(19) United States
(12) Patent Application Publication
(10) Pub. No.: US 2008/0193903 A1
(43) Pub. Date: Aug. 14, 2008

(54) Handheld Addition and Substraction Trainer

(75) Inventor: Young Suk Suh, Daegu-si (KR)

Correspondence Address: CANTOR COLBURN, LLP, 20 Church Street, 22nd Floor, Hartford, CT, 06103, US

(73) Assignee: Young Suk SUH, Daegu-si (KR)

(21) Appl. No.: 11/997,949

(22) PCT Filed: Aug. 16, 2006
(86) PCT No.: PCT/KR2006/003191

§ 371 Date: Feb. 5, 2008

(30) Foreign Application Priority Data
Aug. 16, 2005 (KR) 10-2005-0074901

(51) Int. Cl. G09B 5/00; G06F 15/02

(52) U.S. Cl. 434/201

(57) ABSTRACT

Provided is a handheld addition and subtraction trainer which is designed for kids to improve ability in addition and subtraction and in which a process of presenting an addition and subtraction question with random numbers on a display panel, a process of checking whether a user's answer is correct or not, and a process of presenting a next addition and subtraction question are repeatedly performed. Further, the handheld addition and subtraction trainer has a clock for measuring a user's ability in addition and subtraction by counting the number of correct answers and by measuring a time taken for finding an answer. The handheld addition and subtraction trainer includes: a random number generator which generates a random number used for an addition and subtraction practice; a display panel which displays questions for the addition and subtraction practice, and shows a number that is inputted through the number input element; a power terminal which connects a battery for supplying power; a practice type selector which selects a type of the addition and subtraction practice; a controller which controls a process of the addition and subtraction practice; and a mode selector which selects a clock mode, a timer mode, or a correct answer checking mode. The random number generator generates a random number by using a counter that cyclically counts an address number and a number, a counter output unit that outputs a current value of the counter in response to an interrupt signal, and an interrupt signal generator that generates the interrupt signal. The handheld addition and subtraction trainer includes a timer function and a clock function for measuring a time taken for practicing addition and subtraction, and a function for checking a correct answer. Accordingly, an addition and subtraction question is presented by repeatedly generating the random number so that numbers used in the addition and subtraction question is unpredictable. In addition, since timer and clock functions are provided to measure a time taken for a user to make an answer, the handheld addition and subtraction trainer can help for kids to enhance their ability in addition and subtraction in an effective manner.

### TECHNICAL FIELD

The present invention relates to a handheld addition and subtraction trainer capable of effectively cultivating ability of kids in addition and subtraction.

### BACKGROUND ART

A well-known handheld learning system for kids has been developed such as an educational book, an English learning machine for memorizing English vocabularies, an English conversation learning machine, and a learning machine in which a multiplication table is sequentially reproduced aurally and visually in order to facilitate simple memorizing of the multiplication table.

Addition and subtraction are the most basic processes of arithmetic. In order for kids to cultivate their ability in an addition and subtraction, an execution time has to be measured so that they can find an answer of a question accurately and promptly within a given time by enhancing concentration. Further, an answer has to be immediately checked whether it is correct or not for fast response. Furthermore, for convenience in use, it is necessary for kids to be able to carry the learning system like a book or a notebook. In addition, the kids have to be appropriately motivated in study. Moreover, questions comprising random numbers have to be presented so that the kids can raise their ability for rapidly calculating various types of addition and subtraction questions. Unlike memorizing vocabularies or the multiplication table, it is apparent that an educational advantage is not expected when the several fixed questions are presented with the fixed sequences. Therefore, there is a need for presenting questions comprising unpredictable numbers.

When the kids practice addition and subtraction by using a printed book, they tend to frequently take a recess while calculating, and spend more time than expected due to lack of concentration. Further, once they write down an answer on a sheet of paper by using a pencil or the like, it becomes undesirable to give the same question sheet again for a next time. In the case of a simple memorizing assistance tool such as a multiplication table memorizing tool, questions are not presented with random numbers, and thus the kids may be bored and lose concentration. In addition, a clock has to be additionally prepared to measure the time taken for finding answers.

### DISCLOSURE OF INVENTION

### Technical Problem

In order to solve the aforementioned problems, an object of the present invention is to provide a handheld addition and subtraction trainer, which is implemented with a downsized electronic device that can be conveniently carried and be easily used by kids. In addition, the handheld addition and subtraction trainer includes timer and clock functions for measuring how fast the kids can find an answer of a presented question with concentration. Further, in order to enhance a learning effect, the downsized handheld addition and subtraction trainer includes a simple and effective random number generator that generates a random number for an addition and subtraction question composed of random numbers. Furthermore, the handheld addition and subtraction trainer includes various functions for facilitating concentration and motivating the kids, for example, measuring the kid's computation ability so as to effectively cultivate an addition and subtraction operating capability.

### Technical Solution

According to an aspect of the present invention, there is provided a handheld addition and subtraction trainer, comprising: a random number generator which generates a random number used for an addition and subtraction practice; a number input element through which a number is inputted; a start element through which the addition and subtraction practice starts; a stop element through which the addition and subtraction practice stops; a display panel which displays questions for the addition and subtraction practice, and shows a number that is inputted through the number input element; a first memory which stores a number that is a response from a user with respect to a question generated for the addition and subtraction practice; a power terminal which connects a battery for supplying power; a practice type selector which selects a type of the addition and subtraction practice; an arithmetic logic unit which computes and compares numbers used for the addition and subtraction practice; and a controller which is connected to the number input element, the first memory, the random number generator, and the arithmetic logic unit, and controls a process of the addition and subtraction practice.

### BRIEF DESCRIPTION OF THE DRAWINGS

FIG. 1 is a perspective plan view illustrating an exemplary exterior of a handheld addition and subtraction trainer according to an embodiment of the present invention;

FIG. 2 is a partial plan view illustrating various indexes for indicating an operation state of a handheld addition and subtraction trainer according to an embodiment of the present invention;

FIG. 3 a rear perspective view of a handheld addition and subtraction trainer according to an embodiment of the present invention;

FIG. 4 is a perspective view illustrating a clock mode operation of a handheld addition and subtraction trainer according to an embodiment of the present invention;

FIG. 5 illustrates an internal structure including a random number generator of a handheld addition and subtraction trainer according to an embodiment of the present invention;

FIG. 6 illustrates an internal structure including a random number generator of a handheld addition and subtraction trainer according to another embodiment of the present invention;

FIG. 7 illustrates another random number generator of a handheld addition and subtraction trainer according to an embodiment of the present invention;

FIG. 8 is a timing diagram of an interrupt signal generator of a handheld addition and subtraction trainer according to an embodiment of the present invention;

FIG. 9 is a circuit diagram illustrating main functions of output units of an address counter and a ring counter of a handheld addition and subtraction trainer according to an embodiment of the present invention; and

FIG. 10 is a flowchart illustrating an operation of a handheld addition and subtraction trainer according to an embodiment of the present invention.

### BEST MODE FOR CARRYING OUT THE INVENTION

A handheld addition and subtraction trainer, comprising: a random number generator which generates a random number used for an addition and subtraction practice; a number input element through which a number is inputted; a start element through which the addition and subtraction practice starts; a stop element through which the addition and subtraction practice stops; a display panel which displays questions for the addition and subtraction practice, and shows a number that is inputted through the number input element; a first memory which stores a number that is a response from a user with respect to a question generated for the addition and subtraction practice; a power terminal which connects a battery for supplying power; a practice type selector which selects a type of the addition and subtraction practice; an arithmetic logic unit which computes and compares numbers used for the addition and subtraction practice; and a controller which is connected to the number input element, the first memory, the random number generator, and the arithmetic logic unit, and controls a process of the addition and subtraction practice.

Hereinafter, exemplary embodiments of the present invention will be described in detail with reference to the accompanying drawings.

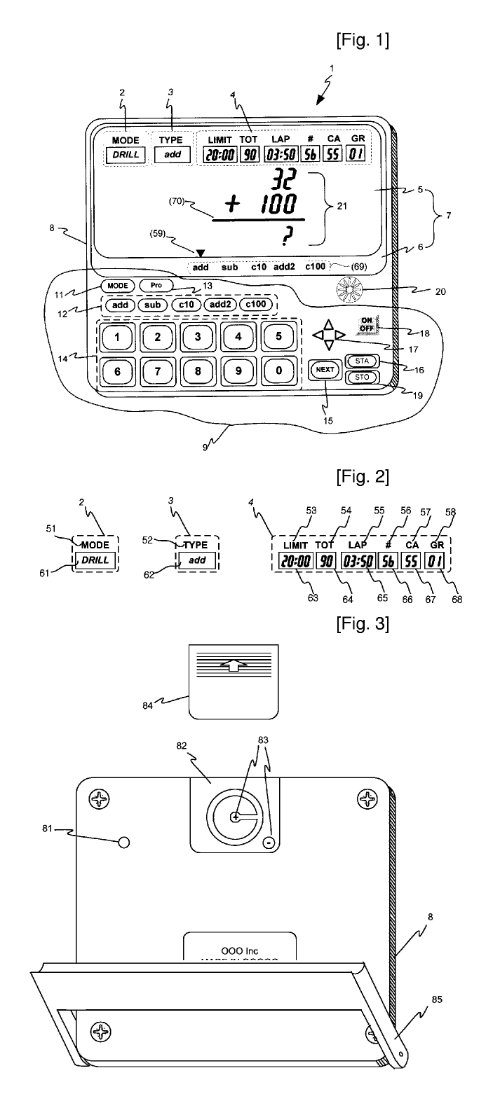

FIG. 1 is a perspective plan view illustrating an exemplary exterior of a handheld addition and subtraction trainer according to an embodiment of the present invention.

The handheld addition and subtraction trainer can be constructed to have a basic exterior in various forms. For example, the handheld addition and subtraction trainer may have a plate shape as shown in FIG. 1. Further, the outer surface of the plate may be decorated with a variety of animals or cartoon characters favored by kids. For convenience in use, the handheld addition and subtraction trainer is downsized so as to be carried.

Referring to FIG. 1, the handheld addition and subtraction trainer 1 according to the present embodiment includes operation elements 9, a speaker 20, and a display part 7 which displays information.

The operation elements 9 are means for operating a variety of functions of the handheld addition and subtraction trainer 1 and inputting numbers into the handheld addition and subtraction trainer 1, and the operation elements are located on the front side thereof.

The operation elements include various elements, for example, the operation elements 9 include a mode selector 11, a practice type selector 12, a property setting element 13, a number input element 14, an input confirming element 15, a start element 16, a stop element 19, a direction moving element 17, and a power switch 18.

These elements can be realized in various forms such as a rubber dome type key or a push switch.

In order to simply realize the above elements, the rubber dome type key is preferably used. A mark representing a key's function may be labeled on the surface of the key or its vicinity by using printing, engraving, or embossing method.

The number input element 14 is a means for inputting numbers into the handheld addition and subtraction trainer 1 for various processes which are performed by the handheld addition and subtraction trainer 1. The number input elements can be realized using a key whose function is inputting a number

The direction moving element 17 can be realized as a direction moving keys. For convenience in use, the direction moving element 17 can easily move up and down and left and right a position of a cursor displayed on a screen.

The input confirming element 15 can be realized as an input confirming key. The input confirming element 15 is a means for sending an effect of a key operation into an internal circuit. The input confirming element 15 is used when a number is inputted in the handheld addition and subtraction trainer 1 or other operation elements is operated, and thereafter a result thereof needs to be sent to an internal circuit.

The mode selector 11 serves to select one mode in various operation modes of the handheld addition and subtraction trainer 1. For example, the mode selector 11 can select one mode in various modes such as an addition and subtraction practice mode, a correct answer checking mode, a clock mode, or a timer mode.

The mode selector 11 can cyclically select the addition and subtraction practice mode, the correct answer checking mode, the clock mode, and the timer mode when the mode selector is sequentially pressed. Further, the mode selector 11 can be constructed separately, such that separate keys are respectively provided for each of the above modes.

The addition and subtraction practice mode is defined as a mode in which a user performs an addition and subtraction practice that is a main function of the present invention. The correct answer checking mode is defined as a mode in which a wrong answer is checked after the practice is ended. In this mode, the user can directly input an addition and subtraction question through the number input element 14 to obtain a correct answer from the handheld addition and subtraction trainer 1. Clock mode is used for a conventional clock, when the clock mode is selected, a conventional digital clock function is performed. Timer mode is used for a conventional timer, when the timer mode is selected, a conventional electronic timer function is performed.

The handheld addition and subtraction trainer 1 has a number computing function. For the clock mode and timer mode, if some additional circuits are added to a circuit for performing the addition and subtraction practice, the conventional clock function and the conventional timer function can be realized in the addition and subtraction trainer.

A clock driving circuit 141 of FIG. 5 is a circuit for realizing a clock function, and includes several circuits for counting and processing hours, minutes, and seconds.

Further, the clock driving circuit 141 can be used for supporting a timer function to check how fast a user of the handheld addition and subtraction trainer 1 can carry out an addition and subtraction practice. The clock driving circuit 141 can be usefully utilized for a clock when the addition and subtraction practice is not carried out.

A timer driving circuit 142 is a circuit for realizing a timer function, and the timer driving circuit 142 measures the duration time between a starting time and an ending time and carry out the post processing for the measured time. This function can be used as a table clock for kids, or can be used as a timer when the kids study other subjects in a limited time.

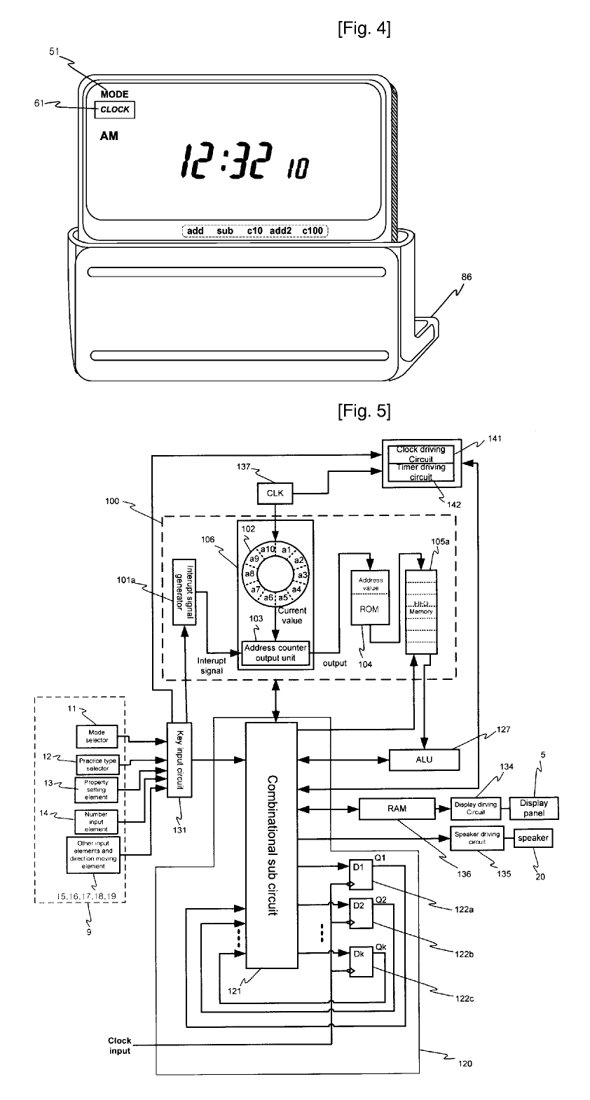

FIG. 4 is a perspective view illustrating an example of the handheld addition and subtraction trainer 1 when in the clock mode.

An example of displaying a current selected mode is shown in detail in FIG. 2.

FIG. 2 is an enlarged view illustrating an upper portion of FIG. 1. Referring to FIG. 2, a mode index 2 is composed of a mode indicator 51 and a mode state display section 61. The mode indicator 51 represents that information displayed on the mode state display section 61 is a kind of mode. For example, if “DRILL” is displayed on the mode state display section 61, this means the addition and subtraction practice mode is running. If “CLOCK” is displayed thereon, the clock mode is running. If “TIMER” is displayed thereon, the timer mode is running. If “CAL” is displayed thereon, the correct answer checking mode is running.

In a specific mode, the operation elements 9 perform a corresponding specific role according to the specific mode. For example, the start element 16, which allows the addition and subtraction practice to start when in the addition and subtraction mode, can be used for triggering a start of time measurement in the timer mode. Further, the number input element 14, which is used for inputting a number when in the addition and subtraction mode, can be used for setting a time when in the clock mode.

The practice type selector 12 can be composed of practice type selecting keys. Further, the practice type selector 12 selects a part of various types of addition and subtraction practice.

Examples of the types of addition and subtraction practice include an addition practice, a subtraction practice, a 10's complement practice, a single digit number addition practice, a two-digit number addition practice, and a 100's complement practice which is to find out a number to be added with a given number in order to make 100. These practices are only examples, and thus other types of addition and subtraction practices can be further added.

A selected type of addition and subtraction practice can be signed by using a practice type index 3 of FIG. 2. A first practice type indicator 52 of the practice type index 3 indicates that a displayed information is a specific practice type. For example, if “add” is displayed on a first practice type display section 62, the addition practice is selected.

In order to display various information on the handheld addition and subtraction trainer 1, a mark printed in a display frame may be used in association with an indicator that is displayed on a display panel 5. For example, instead of displaying by using the practice type index 3, as shown in FIG. 1, a second practice type display section 69 in which a mark is engraved on the display frame 6 and a second practice type indicator 59 having a triangle shape can be used for displaying of information. Further, when a specific practice type is selected, a sign for this selection can be displayed by the second practice type indicator 59 indicating a specific mark on the display frame 6.

The handheld addition and subtraction trainer 1 has a function for setting and displaying various properties for a method of practice, a condition of practice, a process of practice, and a method of displaying a result in the addition and subtraction practice.

For example, the properties of addition and subtraction practice include various factors such as a maximum question count for practice, a time limit for a practice, a current lap time from a start of a practice, a current question count, a wrong answer correcting property, and score representing methods. The wrong answer correcting property is related with a fact that the same question will be presented again until a user put in a correct answer.

The property setting element 13 can be realized as a property setting key. Further, the property setting element 13 has a function for setting a state of a property for the addition and subtraction practice process. A property index 4 displays the aforementioned various properties on the display panel 5, and a detail thereof is shown in FIG. 2.

The property index 4 includes a time limit indicator 53 and a time limit display section 63 which are used to display a time limit for the addition and subtraction practice, a maximum question count indicator 54 and a maximum question count display section 64 which are used to display a maximum number of questions, a current lap time indicator 55 and a current lap time display section 65 which are used to display a time taken for performing practice, a current question count indicator 56 and a current question count display section 66 which are used to display the question count of a question currently being presented, a correct answer count indicator 57 and a correct answer count display section 67 which are used to display the number of questions that are correctly answered by the user, and an grade level indicator 58 and an grade level display section 68 which are used to display a user's ability for the addition and subtraction.

As an example of setting a property by using the property setting element 13, a setting method is described in which a practice time limit is set to “20 min 00 sec”. When the property setting element 13 is pressed, a number is displayed and blinking on the time limit display section 63 of the property index 4 that indicates the practice limit time. Thereafter, when the input confirming element 15 is pressed after number keys of 2, 0, 0, and 0 are sequentially pressed by using the number input element 14, the time limit is set to “20 min 00 sec”, and the trainer go to the state in which a next property type can be set.

The next property type can be set to the maximum number for presenting questions for practice. In this case, a number displayed and blinking on the maximum question count display section 64 disposed below the maximum question count indicator 54 indicating a fact that the maximum question count can be set in the same method as described above.

The start element 16 is used for starting a certain operation. For example, when in the addition and subtraction practice mode, the start element 16 can be used to start an addition and subtraction operation. As another example, when in a timer mode, the start element 16 can be used to starting a timer.

The stop element 19 has a function for stopping a process or operation currently being performed. When in the addition and subtraction practice mode, the stop element 19 can be used to stop a practice currently being performed.

The display panel 5 is a device that displays information. Preferably, the display panel 5 can be realized with an LCD panel (FIG. 1). According to a method of displaying a pixel of a panel, the LCD panel is classified into a graphic type panel on which a graphic image can be freely displayed, a character type panel on which a character can be freely displayed, and a customized segment type panel on which a specific pattern is engraved in advance according to a user's order. One panel is divided into several sections, and each section can be constructed to be the segment type, the character type, or the graphic type.

In the customized segment type panel, a specific pattern is engraved in advance on a transparent substrate such as glass by using a conductive material capable of marking the specific pattern on a given panel. In comparison with the graphic type panel and the character type panel, the customized segment type panel can reduce memory capacity for display panel. Therefore, the customized segment type panel can be advantageously implemented on a display device that performs a specific function.

In order to display information in a cost competitive and effective manner, the display panel 5 is preferably constructed such that the various indicators 51 to 59, an addition and subtraction indicating vertical line 70, a question display section 21 for displaying an addition and subtraction question, the property state displays section 63 to 68 are implemented to be the segment type. However, the character type or the graphic type panel is also applied to the various indicators 51 to 59, the addition and subtraction indicating vertical line 70, the question display section 21, the property state displays section 63 to 68. Some blocks of a RAM 136 of FIG. 5 can be used as a display memory space for displaying information on the display panel 5.

For example, referring to FIG. 1, a question is displayed on the display panel 5 by using segment type numbers. In this case, the question asks an answer of addition of two numbers, that is, 32+100.

The display frame 6 physically surrounds the display panel 5 of the handheld addition and subtraction trainer 1. The display frame 6 can be integrated with a body 8, and a specific mark can be printed thereon. The mark can be used to show information in association with a specific sign displayed inside the display panel 5.

For example, a selected practice type may be displayed in such a manner that a second practice type display section 69 is printed on the display frame 6, and the triangle shaped second practice type indicator 59 is disposed on the display panel 5, so that the second practice type indicator 59 indicates the selected practice type. In FIG. 1, since “add” shown on the display frame 6 is indicated by the second practice type indicator 59, it can be seen that an addition practice function is performed.

FIG. 3 illustrates an example of a rear side of a handheld addition and subtraction trainer according to an embodiment of the present invention. The handheld addition and subtraction trainer 1 includes a reset switch 81 which recovers all functions when the handheld addition and subtraction trainer 1 is in error, a battery holder 82, a power terminal 83 that effectively mounts a battery thereon and connect with the battery, and a battery cover 84 which is bonded with the battery holder 82.

In order to be used as a table clock or a timer for convenience while being operated in the clock mode or the timer mode, the handheld addition and subtraction trainer 1 includes a support 85 which is attached to one side of a body 8 of the handheld addition and subtraction trainer 1 to prevent the handheld addition and subtraction trainer 1 from falling down, or a support casing 86 in which the handheld addition and subtraction trainer 1 is contained. By utilizing the support 85 and the support casing 86, the handheld addition and subtraction trainer 1 can stand on a flat place.

Referring to FIG. 5, a key input circuit 131 includes a function for recognizing and processing a specific operation of operation elements 11 to 19. The key input circuit 131 further includes a function for recognizing operation progresses of all of the operation elements 11 to 19 and for providing a signal thereof to interrupt signal generators 101a and 101b.

A display driving circuit 134 drives the display panel 5. A speaker 20 generates various sounds while the handheld addition and subtraction trainer 1 operates. A speaker driving circuit 135 drives the speaker 20. A clock generator 137 has a function for providing a clock signal to a circuit requiring a clock.

A clock driving circuit 141 and a timer driving circuit 142 in cooperation can measure a time required for performing the addition and subtraction practice, and are used for a clock and a timer, respectively. A clock pulse is required to drive the clock and the timer. In this case, an address counter 102 can be used for the clock pulse or a ring counter 112 can be used for the clock pulse in a division manner. Alternatively, the clock generator 137 can be directly used for the clock pulse.

An arithmetic logic unit 127 performs calculations of addition, subtraction, and comparison which are required for the addition and subtraction practice.

To enhance a learning effect, addition and subtraction questions needs to be randomly presented while the user operates the handheld addition and subtraction trainer 1. A random number generator that generates a random number is embedded in the handheld addition and subtraction trainer 1 of the present invention.

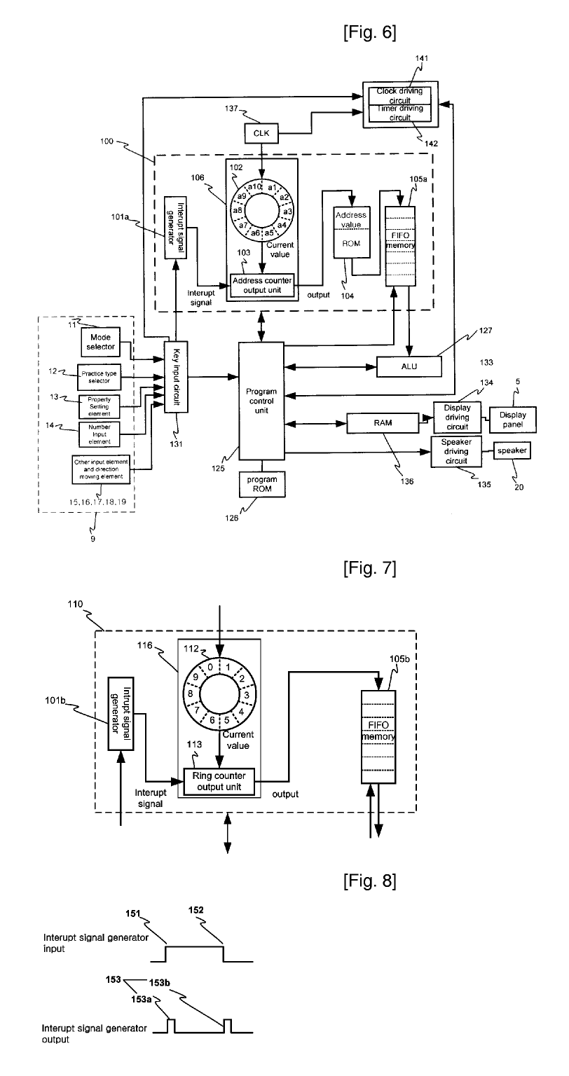

Referring to FIGS. 5 and 6, a random number generator 100 generates a random number required for questions. The random number generator 100 includes a random number memory 104 which is pre-stored with random numbers for addition and subtraction questions and is a non-volatile memory. The random number memory 104 receives an address value from an address generator 106 generating a random address, so the random number memory 104 outputs a random number.

The random number memory 104 outputs a value stored therein when an address is designated. An address of the random number memory 104 is designated randomly with an address value which is sent from an address generator 106. A random address number generated from the address generator 106 designates the address of the random number memory 104. Numbers used for questions are pre-stored in the random number memory 104 when the handheld addition and subtraction trainer 1 is manufactured. The handheld addition and subtraction trainer 1 can uses some blocks of the ROM 104 as a space for the random number memory 104.

Preferably, in order to achieve numbers having the same probability of occurrences, the numbers have to be stored in the random number memory 104 such that numbers of 0 to 9 have the same probability of occurrences. For example, if size of a random number memory 104 is 10, it is preferable that the numbers of 0 to 9 are stored once therein, respectively. If size of random number memory 104 is 30, it is preferable that the numbers of 0 to 9 are stored therein, three per each.

The address generator 106 includes an address counter 102 which cyclically counts an address value in synchronization with a clock generator 137, and an address counter output unit 103 which catch and generates a current value of the address counter 102 as an address value of the address generator 106 in response to an interrupt signal of the interrupt signal generator 101a generating a random interrupt signal.

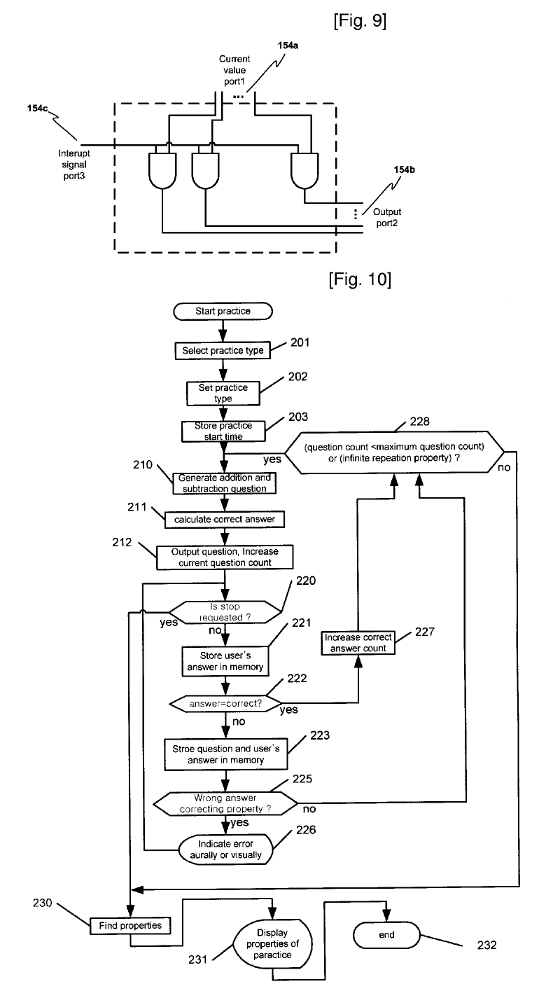

FIG. 9 illustrates an example of the address counter output unit 103. Here, main parts thereof are implemented by using an AND gate.

Referring to FIG. 9, information sent to a first port 154a is sampled without alteration and is transmitted to a second port 154b when an interrupt signal is sent to a third port 154c. The first port 154a is connected to the address counter 102, and the second port 154b is connected to addresses of the random number memory 104. The third port 154c receives the interrupt signal.

For example, as shown in FIG. 6, the address counter 102 cyclically counts ten address numbers a1 to a10. In this case, when an interrupt signal is supplied to the address counter output unit 103, a current address value of the address counter 102, that is, any one of the ten address numbers a1 to a10, is caught and is outputted from the address counter output unit 103, so as to be sent as an address value of random number memory 104.

The interrupt signal generator 101a detects operational changes in the operation elements 9 externally attached to the handheld addition and subtraction trainer 1, and generates random interrupt signals 153a and 153b of FIG. 8.

For example, whatever key of the operation elements 9 is pressed by the user, the interrupt signal generator 101a may generate an interrupt signal instantly after the user presses the key. Two interrupt signals can be generated so that two random address numbers are generated by a single key operation.

Referring to FIG. 8, for example, the interrupt signal generator 101a may output the random interrupt signals 153a and 153b two times by recognizing a rising edge time 151, which is a time for transition from a key-unpressed state to a key-pressed state, and a falling edge time 152 which is a time for transition from a key-pressed state to a key-unpressed state, so as to use the random interrupt signals 153a and 153b as interrupt signals of the address counter output unit 103.

Further, the random number memory 104 can have ten or more storage spaces.

For example, the address counter 102 can cyclically designate 100 addresses, and the random number memory 104 may have 100 address values, where two single-digit numbers are respectively stored in 100 storage spaces, that is, (0,0) is firstly stored, and (0,1), . . . , (9,9) are followed. In this case, when an interrupt signal is supplied for one time, a corresponding address value for the random number memory can be is generated. Thereafter, when the address value designates the random number memory 104, two natural numbers are obtained.

Numbers can be generated for various types of questions by modifying size of storage spaces or size of states for a cyclic address counter. Further, answers of frequently used questions may be also stored along with the questions, so as to be utilized for checking a correct answer.

Random number generator 100 of FIGS. 5 and 6 may further include a second memory 105a in which the random numbers transferred from the random number memory 104 are accumulated.

Preferably, the numbers generated by using the aforementioned method to be used for questions are continuously accumulated in the second memory 105a that is a buffer for storing numbers for questions, so as to be fetched out as many as required when the numbers for questions are needed. When an addition and subtraction question is generated, the numbers are fetched one by one starting from a number which is firstly stored in the second memory 105a.

Preferably, for an effective memory management, the second memory 105a has a First In First Out (FIFO) memory structure in which a firstly incoming number is automatically removed when a memory is full, and a fetched number is automatically deleted.

FIG. 7 illustrates another example of a random number generator. This random number generator can be used for the handheld addition and subtraction trainer 1 in replacement of the random number generator 100 of FIGS. 5 and 6.

A random number generator 110 of FIG. 7 includes a number generator 116 and an interrupt signal generator 101b that generates an interrupt signal. The number generator 116 includes a ring counter 112 that cyclically counts numbers and a ring counter output unit 113 that outputs a current value of the ring counter 112 in response to an interrupt signal. Further, the random number generator 110 generates a value taken from the ring counter 112 as a random number for an addition and subtraction question.

A function for generating a number, which cannot be predicted by the user by using a counter, will be described.

For example, the ring counter 112 cyclically counts ten numbers of 0 to 9 at the same speed as the clock generator 137. The ring counter output unit 113 samples and outputs a current value of the ring counter 112 when an interrupt signal is supplied from the interrupt signal generator 101b. So, any one of currently counted numbers of 0 to 9 of the ring counter 112 is sampled in response of the interrupt signal.

For example, the interrupt signal supplied to the ring counter 112 may be a signal which is generated from the interrupt signal generator 101b whenever the external operation elements 9 operates. At a moment when the user presses an external key with a hand, the interrupt signal generator 101b generates the interrupt signal, and one of the numbers 0 to 9 are output from the ring counter 112. The outputted numbers have the same probability of occurrences, and thus the user cannot predict the output numbers. Therefore, these numbers are used as the random numbers for the addition and subtraction questions.

In order to generate two random numbers at a single key operation, as shown in FIG. 8, the interrupt signal generator 101a can respectively generate the random interrupt signals 153a and 153b at the rising edge time 151, which indicates a time for transition from a key-unpressed state to a key-pressed state, and the falling edge time 152 which indicates a time for transition from a key-pressed state to a key-unpressed state, so as to use the two random interrupt signals 153a and 153b as interrupt signals of the ring counter output unit 113.

Preferably, the numbers generated by using the aforementioned method employing the random number generator 110 of FIG. 7 is continuously accumulated in the second memory 105b that is a buffer for storing numbers for questions, so as to be fetched out as many as required when the numbers for questions are needed.

When a computation question is generated, the numbers are fetched one by one starting from a number which is firstly stored in the second memory 105b. Preferably, for an effective memory management, the second memory 105b has a First In First Out (FIFO) memory structure in which a firstly incoming number is automatically removed when a memory is full, and a fetched number is automatically deleted.

The ring counter 112 may have ten or more states. For example, the ring counter 112 may cyclically designate one hundred numbers 0 to 99. In this case, if 0 corresponds to (0,0), two single-digit natural numbers can be obtained when an interrupt signal is supplied for one time. For example, if the output number is 36, random numbers 3 and 6 are generated.

Numbers for various types of questions can be generated by modifying the number of states of the ring counter 112 or modifying numbers assigned for each state.

A program control unit is a controller that controls various functions of the handheld addition and subtraction trainer 1 by processing a program that is executed in connection with a program ROM 126 and the arithmetic logic unit 127 for the various functions of the handheld addition and subtraction trainer 1. The program ROM 126 is a non-volatile memory for storing a program including sequential control commands. The program control unit executes the commands stored in the program ROM 126 one by one. The command is executed according to an operation of external keys of the handheld addition and subtraction trainer 1.

A sequential logic circuit 120 is connected to the number input element 14, a first memory, and the random number generator 100, and is a controller that has a function for controlling the process of addition and subtraction practice.

The sequential logic circuit 120 performs several functions pre-defined initially. Further, the sequential logic circuit 120 can be a Moore machine in which an output thereof is represented as a function of a current state alone, or a Mealy machine in which an output thereof is represented as a function of current states and current inputs. The sequential logic circuit 120 is designed to perform various modes and functions of the handheld addition and subtraction trainer 1.

FIG. 5 illustrates an example of the aforementioned sequential logic circuit 120. The sequential logic circuit 120 sequentially performs various functions of the handheld addition and subtraction trainer 1 according to an operation of external keys.

A first memory is required to construct the handheld addition and subtraction trainer 1 of the present invention. When an addition and subtraction question is presented to the user, a response of the user is stored in the first memory. Thereafter, the handheld addition and subtraction trainer 1 compares a number stored in the first memory with a correct answer calculated by the handheld addition and subtraction trainer 1 in itself, and determines whether the user's answer is correct or not.

A partial space of a writable memory RAM 136 (FIG. 5), can be used as a storage space for displaying information on the display panel 5. Another partial space thereof may be assigned for various memory spaces required for the handheld addition and subtraction trainer 1.

The random number memory 104 and the program ROM 126 may be realized of a read only memory or a flash memory. The first memory and the second memories 105a and 105b, and the RAM 136 is writable memories, and thus may be realized of a flash memory or a DRAM.

FIG. 10 is a flowchart illustrating an operation of the handheld addition and subtraction trainer 1 according to an embodiment of the present invention. A power switch 18 is pressed to supply power in case the handheld addition and subtraction trainer 1 turns off, and an addition and subtraction practice mode is selected by pressing the mode selector 11. In this case, random numbers are generated by the random number generator 100 of FIGS. 5 and 6 whenever an external key operations, and are sequentially stored in the second memory 105a.

Thereafter, an addition and subtraction practice starts.

Detailed operations thereof will be described with reference to FIG. 10.

In a step 201 of selecting a practice type, the practice type selector 12 is pressed to select a practice type. For example, if a practice process for adding two numbers is selected, as shown in FIG. 1, “add” is displayed on the first practice type display section 62 to indicate that the practice process for adding two numbers is performed.

In a step 202 of setting several practice properties, various properties are set by using the property setting element 13.

In a step 203 of storing a practice start time, the start key 16 is pressed to start a computation practice. In this case, the handheld addition and subtraction trainer 1 stores a practice start time in an internal memory, to be used when a time taken for practice is displayed some time later.

In a step 210 of generating an addition and subtraction question, a required number is fetched from the second memory 105 to generate a question for practice. For example, if six numbers, that is, 0, 3, 2, 1, 0, and, 0, are respectively fetched, a generated question may be “32+100=?”.

In a step 211 of finding a correct answer, a correct answer for the question is calculated, and is stored in the first memory for storing user's answers.

In a step 212 of displaying a question and increasing of a current question count, the question generated in the step 210 is displayed on the display panel 5 in the same manner as illustrated in a question display section 21 of FIG. 1. Further, a current question count is increased by 1, and is then displayed on the current question count display section 66.

In a step 220 of checking a stop request, it is determined whether the stop element 19 operates or not. If a stop request exists, a step 230 of catching properties is performed. Otherwise, a step 221 of storing an answer in a memory is performed.

In the step 221, the user inputs an answer, and the answer is then stored in the first memory.

In a step 222 of determining whether an answer is correct, a user's answer is compared with a correct answer calculated by the handheld addition and subtraction trainer 1. If it is correct, a step 227 of increasing the number of correct answers is performed. Otherwise, a step 223 of storing a question and an answer in a memory for storing a wrong answer set is performed.

In the step 223, a question and a user's wrong answer are stored in a memory for storing a wrong answer. The memory for storing a wrong answer can be constructed by using some blocks of the RAM 136.

In a step 225 of asking a wrong answer correcting property, if the wrong answer correcting property is selected before a practice is performed, a step 226 of indicating an error in an aural or visual manner is performed. Otherwise, a step 228 of checking whether the number of questions executed is less than the maximum question count, or whether a property for infinite execution exits, is performed.

In the step 226, the speaker 20 or the display panel 5 are used to indicate as a sign of wrong answer, and the step 220 is performed again.

In the step 227, if the user's answer coincides with the correct answer, the number of correct answers is increased, and the step 228 is performed.

In the step 228, if a currently presented question does not reach a predetermined maximum question count, or if the property for infinite execution is selected, the step 210 is performed again. Otherwise, the step 230 is performed.

In the step 230, various property parameters are found to display a result of practice. For example, a grade level may be estimated by calculating a time taken for practice or a ratio of correct and wrong answer.

After the step 230, a step 231 of displaying property parameters for a result of practice is performed. In the step 231, various property parameters are displayed on the display panel 5. For example, information such as the grade level may be displayed on the grade level display section 68.

In a step 232 of ending process, the addition and subtraction practice process is ended.

### INDUSTRIAL APPLICABILITY

Accordingly, a handheld addition and subtraction trainer of the present invention includes a random number generator, so that a random number is continuously generated by recognizing an operation element or key operation during practice. As a result, since addition and subtraction questions with random numbers are presented, a learning effect of addition and subtraction can be enhanced for a user.

In addition, since the handheld addition and subtraction trainer of the present invention includes a clock having a timer function for measuring a practice execution time, the user can upgrade his ability for the rapid and accurate execution of the add and subtract with concentration within a given time.

In addition, since the handheld addition and subtraction trainer of the present invention includes a practice type selector, various types of questions for the addition and subtraction can be selected. Further, since a grade level is displayed, the trainer gives users aim for practicing repeatedly and continuously.

1. A handheld addition and subtraction trainer, comprising:
a random number generator which generates a random number used for an addition and subtraction practice;
a number input element through which a number is inputted;
a start element through which the addition and subtraction practice starts;
a stop element through which the addition and subtraction practice stops;
a display panel which displays questions for the addition and subtraction practice, and shows a number that is inputted through the number input element;
a first memory which stores a number that is a response from a user with respect to a question generated for the addition and subtraction practice;
a power terminal which connects a battery for supplying power;
a practice type selector which selects a type of the addition and subtraction practice;
an arithmetic logic unit which computes and compares numbers used for the addition and subtraction practice; and
a controller which is connected to the number input element, the first memory, the random number generator, and the arithmetic logic unit, and controls a process of the addition and subtraction practice.

2. The handheld addition and subtraction trainer according to claim 1, further comprising a clock driving circuit which is used for a clock mode.

3. The handheld addition and subtraction trainer according to 1, further comprising a timer driving circuit which is used for a timer mode.

4. The handheld addition and subtraction trainer according to 1, further comprising
a mode selector that includes a function for selecting a correct answer checking mode,
whereby an addition and subtraction question is inputted through the number input element and processed, and a correct answer for the question is displayed in the correct answer checking mode.

5. The handheld addition and subtraction trainer according to 1, wherein the random number generator includes a random number memory which is non-volatile and pre-stored with random numbers for addition and subtraction questions,
and generates a random number by receiving an address value from an address generator that generates a random address value.

6. The handheld addition and subtraction trainer according to 5, wherein the address generator comprises:
an address counter which cyclically changes a state thereof in synchronization with a clock generator, and outputs an address value; and
an address counter output unit which generates a current value of the address counter as an address in response to an interrupt signal of an interrupt signal generator that generates a random interrupt signal.

7. The handheld addition and subtraction trainer according to 6, wherein the interrupt signal generator detects operational changes in an operation element which is externally attached to the handheld addition and subtraction trainer, and generates a random interrupt signal.

8. The handheld addition and subtraction trainer according to 5, wherein the random number generator further comprises a second memory in which random number transferred from the random number memory is accumulated.

9. The handheld addition and subtraction trainer according to 1, wherein the random number generator comprises:
a ring counter which cyclically changes a state thereof in synchronization with a clock generator; and
a ring counter output unit which generates a current value of the ring counter as a random number in response to an interrupt signal of an interrupt signal generator that generates a random interrupt signal.

10. The handheld addition and subtraction trainer according to 9, wherein the interrupt signal generator detects operational changes in operation element externally attached to the handheld addition and subtraction trainer, and generates a random interrupt signal.

11. The handheld addition and subtraction trainer according to 9, wherein the random number generator further comprises a second memory in which a generated random number is accumulated.

12. The handheld addition and subtraction trainer according to 1, wherein the display panel is a segment type custom LCD display panel in which patterns that mark a property indicator indicating a property type of the addition and subtraction practice,
a mode indicator indicating a mode type of the handheld addition and subtraction trainer,
or a practice type indicator indicating a type of the addition and subtraction practice
is engraved on a glass substrate by using a conductive material.

13. The handheld addition and subtraction trainer according to 1, wherein the controller is a sequential logic circuit type controller that uses a sequential logic circuit.

14. The handheld addition and subtraction trainer according to 13, wherein the sequential logic circuit is a Mealy machine type sequential logic circuit of which an output is represented as a function of current states and inputs of the sequential logic circuit.

15. The handheld addition and subtraction trainer according to 1, wherein the controller is a program control unit type controller having a program control unit and the program control unit is connected to a program ROM that is a non volatile memory and stored with an execution program for a process of the addition and subtraction practice, whereby the program control unit executes a control command stored in the program ROM.

16. The handheld addition and subtraction trainer according to 1, wherein the practice type selector has a function for selecting any one from an addition practice, a subtraction practice, a 10's complement practice, and 100's complement practice.

17. The handheld addition and subtraction trainer according to 1, wherein the handheld addition and subtraction trainer further comprises a support which is attached to one side of a body of the handheld addition and subtraction trainer to prevent the handheld addition and subtraction trainer from falling down, or a support casing in which the handheld addition and subtraction trainer is contained.
